(19) United States
(12) Patent Application Publication
(10) Pub. No.: US 2008/0081642 A1
(43) Pub. Date: Apr. 3, 2008

(54) METHOD AND APPARATUS FOR ESTIMATING SIGNAL QUALITY BITMAP FOR CELLS

(75) Inventors: Yiling XU, Suwon-si (KR); Jae-Yeon Song, Seoul (KR); Kook-Heui Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/835,193

(22) Filed: Aug. 7, 2007

Related U.S. Application Data
(60) Provisional application No. 60/835,886, filed on Aug. 7, 2006.

(30) Foreign Application Priority Data
Jun. 29, 2007 (KR) 65307/2007

(51) Int. Cl. H04Q 7/20

(52) U.S. Cl. 455/456.5; 455/456.6

(57) ABSTRACT

Provided is a method and apparatus for estimating a signal quality bitmap for cells. Maps for a popular frequency are assumed as a benchmark bitmap and maps for other frequencies are constructed based on the benchmark bitmap, thereby remarkably reducing cost imposed by map generation and broadcasting.

### CROSS-REFERENCE TO RELATED PATENT APPLICATION

This application claims the benefit under 35 U.S.C. § 119(a) of a U.S. Provisional Patent Application filed in the U.S. Patent Office on Aug. 7, 2006 and assigned Ser. No. 60/835,886 and a Korean Patent Application filed in the Korean Intellectual Property Office on Jun. 29, 2007 and assigned Serial No. 2007-65307, the entire disclosures of which are hereby incorporated by reference.

### BACKGROUND OF THE INVENTION

1. Field of the Invention

The present invention generally relates to a mobile communication system, and more particularly to a method and apparatus for estimating a signal quality bitmap for cells.

2. Description of the Related Art

During a decision process for handover of a mobile terminal, the signal quality of signals that are instantaneously received from multiple cells or location information that is received together with cell coverage data is explored in traditional systems. Those traditional methods, although widely used in existing systems, exhibit obvious shortcomings of always resulting in less educated handover decisions which could lead to a high possibility of frequent handover and degradation of average signal quality.

Recently, a handover method based on bitmaps indicating received signal quality at different locations within neighboring cells is introduced in U.S. Patent Publication No. 2005/0192031. According to this method, mobile terminals or fixed receivers in a network report their received signal quality at their current locations to a central subsystem and the subsystem generates a rough map showing a received signal level from each terminal in each cell, i.e., a bitmap. Those bitmaps are then broadcasted to the terminals in the cell and periodically updated.

Of course, an ad-hoc-like map sharing mechanism may be used instead of the bitmap scheme, depending on a system requirement. An ad-hoc-like map is generally a square N×N bitmap, spanning the whole coverage range of a cell. Each pixel of the map is assigned some bits as indicators of a received signal level. The received signal level has to be determined by averaging the received signal quality during a certain period of time in order to eliminate multi-path fading such as path loss and shadowing and to retain large-scale fading.

In practical Digital Video Broadcasting (DVB) systems, there exist several transmitters at an emitting site, each of which broadcasts a transport stream. Hereinafter, the emitting site and the transmitter will be used together for the same meaning. Each transmitter usually has its unique modulating frequency. Thus, among neighboring cells, the same service may be carried by signals with different carrier frequencies.

As is well known, the amount of path-loss and shadowing are inversely proportional to carrier frequencies. Thus, it may be expected that signal quality maps generated for different frequencies could be different in terms of the ratio of a ‘good’ signal strength region and a ‘poor’ signal strength region. Ideally, there could be multiple maps for each cell, each of which corresponds to a single carrier frequency. In this case, a terminal needs to collect several maps of neighboring cells for the current service each time it starts handover planning.

### SUMMARY OF THE INVENTION

An aspect of the present invention is to address at least the above problems and/or disadvantages and to provide at least the advantages described below. Accordingly, an aspect of the present invention is to provide a method and apparatus for estimating bitmaps for other frequencies using an already-known benchmark bitmap for a frequency.

According to one aspect of the present invention, there is provided a method for estimating a signal quality bitmap for cells. The method includes receiving a benchmark bitmap including a signal quality value for every position within a cell where a receiver is currently located according to a first frequency from an emitting site of the cell, estimating a signal quality value for every position within the cell according to a second frequency using the signal quality value for every position in the received benchmark bitmap, and constructing an estimated bitmap using the estimated signal quality value.

According to another aspect of the present invention, there is provided a method for estimating a signal quality bitmap for cells by a network in a digital broadcasting system. The method includes receiving a test result with respect to a reference signal having a first frequency from a test terminal to construct a benchmark bitmap, estimating a bitmap for another signal having a second frequency based on the benchmark bitmap to transmit the estimation result to the terminal using Program Specific Information/Service Information (PSI/SI) or transmit the estimation result as a service to the terminal, and collecting parameters for estimating a bitmap for the another signal to transmit the collected parameters to the terminal using PSI/SI or transmit the collected parameters as a service to the terminal.

According to another aspect of the present invention, there is provided a method for estimating a signal quality bitmap for cells by a terminal in a digital broadcasting system. The method includes checking if a bitmap is received from a network, if the bitmap is received, checking if the received bitmap is a benchmark bitmap for a reference signal having a first frequency, estimating a bitmap for another signal having a second frequency based on the benchmark bitmap if the benchmark bitmap for the reference signal is received, and searching for a candidate cell using the estimation result, and performing handover according to the search result.

According to another aspect of the present invention, there is provided a network device which provides a broadcast service to a terminal and estimates a signal quality bitmap for cells in a digital broadcasting system. The network device includes a Service Application (SA) for aggregating contents from sources and their related metadata in order to provide an application for a particular service and a Service Management (SM) for generating an Electronic Service Guide (ESG) for the broadcast service from the metadata collected by the SA and managing roaming of the terminal to a neighboring network. The SM receives a test result with respect to a reference signal having a first frequency from a test terminal to construct a benchmark bitmap, estimates a bitmap for another signal having a second frequency based on the benchmark bitmap to transmit the estimation result to the terminal using Program Specific Information/Service Information (PSI/SI) or transmit the estimation result as a service to the terminal and collects parameters for estimating a bitmap for the another signal to transmit the collected parameters to the terminal using PSI/SI or transmit the collected parameters as a service to the terminal.

According to another aspect of the present invention, there is provided a terminal device which receives a broadcast service from a network and estimates a signal quality bitmap for cells in a digital broadcasting system. The terminal device includes a broadcasting receiver for receiving a broadcast service or signal from a broadcast network, an interactive adaptor for receiving an interactive service or signal from an interactive network, and a mobility management and control for managing roaming to a neighboring network. The broadcasting receiver receives mapping information for services provided from different IP platforms or different providers from a network, and the mobility management and control checks if a received bitmap is a benchmark bitmap for a reference signal having a first frequency if the bitmap is received from a network, estimates a bitmap for another signal having a second frequency based on the benchmark bitmap if the benchmark bitmap for the reference signal is received and searches for a candidate cell using the estimation result, and performs handover according to the search result.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a flowchart illustrating a process of bitmap estimation and handover according to an exemplary embodiment of the present invention;

FIG. 2 illustrates a benchmark bitmap according to an exemplary embodiment of the present invention;

FIG. 3 illustrates an estimated bitmap according to an exemplary embodiment of the present invention;

FIG. 4 is a block diagram of a Digital Video Broadcasting-Handheld (DVB-H) system to which the present invention is applied;

FIG. 5 is a flowchart illustrating the operation of a network according to an exemplary embodiment of the present invention;

FIG. 6 is a flowchart illustrating the operation of a terminal according to an exemplary embodiment of the present invention;

FIG. 7 schematically illustrates the structure of a terminal according to an exemplary embodiment of the present invention; and

FIG. 8 schematically illustrates the structure of a network according to an exemplary embodiment of the present invention.

Throughout the drawings, the same drawing reference numerals will be understood to refer to the same elements, features and structures.

### DETAILED DESCRIPTION OF THE EXEMPLARY EMBODIMENT

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

The present invention is based on the fact that for each pixel in an existing bitmap the amount of changes in received signal strength within the pixel can be estimated by considering changes in path loss and shadowing due to carrier frequency shift. In other words, by comparing the change of signal quality with a certain threshold, it is possible to roughly determine received signal strength for a new carrier frequency (‘better’, ‘worse’, ‘good to bad’, ‘bad to good’, and the like). Repeating the above process may lead to a new estimated map for the new carrier frequency. According to the present invention, high cost imposed by map generation and broadcasting can be greatly reduced by assuming maps for a ‘popular’ frequency as a benchmark bitmap and constructing maps for other frequencies based on the benchmark bitmap. In addition, requirements for reliable transmission of multiple maps can be alleviated and the quality of different-frequency maps can be maintained in a fairly reliable fashion, while the total overload of map sharing can be reduced.

Hereinafter, a method for estimating a bitmap for a single frequency based on a benchmark bitmap according to an exemplary embodiment of the present invention will be described.

Free space power received by a receiver antenna that is separated from a radiating transmitter antenna by a distance d is given by the Friis free space equation,

$${P}_{r} ( d ) = \frac{{P}_{t} {G}_{t} {G}_{r} {λ}^{2}}{{( 4 π )}^{2} {d}^{2} L} , \qquad ( 1 )$$

where Pᵣ(d) is received power that is a function of the T-R separation, Pₜ is transmitted power, Gₜ is a transmitter antenna gain, Gᵣ is a receiver antenna gain, d is a T-R separation distance in meters, L is a system loss factor that is not related to propagation (L≧1), and λ is a wavelength in meters and is related to a carrier frequency (f) by

$$λ = \frac{c}{f} . \qquad ( 2 )$$

where c is a constant indicating the speed of light (=300000 km/h).

Thus, Equation (1) can be

$${P}_{r} ( d ) = \frac{{P}_{t} {G}_{t} {G}_{r} {c}^{2}}{{( 4 π )}^{2} {d}^{2} {Lf}^{2}} \qquad ( 3 )$$

If there are two transmitters, i.e. a transmitter 1 and a transmitter 2, in an emitting site, Pᵣ₁(d) is received power from the transmitter 1 and Pᵣ₂(d) is transmitted power from the transmitter 2. The relationship between Pᵣ₁(d) and Pᵣ₂(d) can be expressed as follows:

$$\frac{{P}_{r 1} ( d )}{{P}_{r 2} ( d )} = \frac{{P}_{t 1} {G}_{t 1} {G}_{r 1} {c}^{2}}{{( 4 π )}^{2} {d}_{1}^{2} {Lf}_{1}^{2}} * \frac{{( 4 π )}^{2} {d}_{2}^{2} {Lf}_{2}^{2}}{{P}_{t 2} {G}_{t 2} {G}_{r 2} {c}^{2}} \qquad ( 4 )$$

Equation (4) can be simplified to be

$$\frac{{P}_{r 1} ( d )}{{P}_{r 2} ( d )} = \frac{{P}_{t 1} {G}_{t 1} {G}_{r 1} {d}_{2}^{2} {f}_{2}^{2}}{{P}_{t 2} {G}_{t 2} {G}_{r 2} {d}_{1}^{2} {f}_{1}^{2}} \qquad ( 5 )$$

If the received power from the transmitter 1 is known, then the received power for the transmitter 2 can be estimated using

$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}} \qquad ( 6 )$$

Thus, for every position within a cell where the received power of the transmitter 1 is measured, the received power of the transmitter 2 in the same position is

$${P}_{r 2} ( d ) = {P}_{r 1} ( d ) * \frac{{P}_{t 2} {G}_{t 2} {G}_{r 2} {f}_{1}^{2}}{{P}_{t 1} {G}_{t 1} {G}_{r 1} {f}_{2}^{2}} \qquad ( 7 )$$

For the receiver having the same antenna gain, Equation (7) can be arranged to

$${P}_{r 2} ( d ) = {P}_{r 1} ( d ) * \frac{{P}_{t 2} {G}_{t 2} {f}_{1}^{2}}{{P}_{t 1} {G}_{t 1} {f}_{2}^{2}} \qquad ( 8 )$$

On the other hand, the T-R separation distances of the receiver for the same received power from the transmitter 1 and the transmitter 2 are also different and their relationship is

$$\frac{{d}_{2}^{2}}{{d}_{1}^{2}} = \frac{{P}_{t 2} {G}_{t 2} {f}_{1}^{2}}{{P}_{t 1} {G}_{t 1} {f}_{2}^{2}} \\ {d}_{2} = \sqrt{\frac{{P}_{t 2} {G}_{t 2}}{{P}_{t 1} {G}_{t 1}}} * \frac{{f}_{1}}{{f}_{2}} * {d}_{1} \qquad ( 9 )$$

If the transmitted powers from the transmitter 1 and the transmitter 2 and the antenna gains of the transmitter 1 and the transmitter 2 are the same, the receiver antenna gains of the transmitter 1 and the transmitter 2 are also the same. Thus, Equations (5), (7), and (9) can be written as

$$\frac{{P}_{r 1} ( d )}{{P}_{r 2} ( d )} = \frac{{d}_{2}^{2} {f}_{2}^{2}}{{d}_{1}^{2} {f}_{1}^{2}} \\ {P}_{r 2} ( d ) = {P}_{r 1} ( d ) * \frac{{f}_{1}^{2}}{{f}_{2}^{2}} \\ {d}_{2} = \frac{{f}_{1}}{{f}_{2}} * {d}_{1} \qquad ( 10 )$$

Using this method according to an exemplary embodiment of the present invention, based on a benchmark bitmap constricted according to the test result of a frequency signal, a bitmap for other-frequency signals can be calculated. If a terminal knows transmitted powers and antenna gains of two transmitters or the ratio thereof and a receiver antenna gain, it can calculate a bitmap for another signal based on the benchmark bitmap.

For different frequencies, the size of a bitmap varies. The scope of a signal with low frequency is larger than that of a signal with high frequency. Thus, if a bitmap with low frequency is used as a benchmark bitmap to estimate a bitmap with high frequency, there would be no problem. This is because every position within the scope, a benchmark signal value in the known benchmark bitmap can be found using Equation (7). In contrast, if a benchmark value does not exist because the scope of the estimated bitmap is larger than a reference one, the signal value out of the reference scope could be estimated using Equation (6).

Hereinafter, a method for estimating a bitmap according to the present invention will be described using a detailed embodiment.

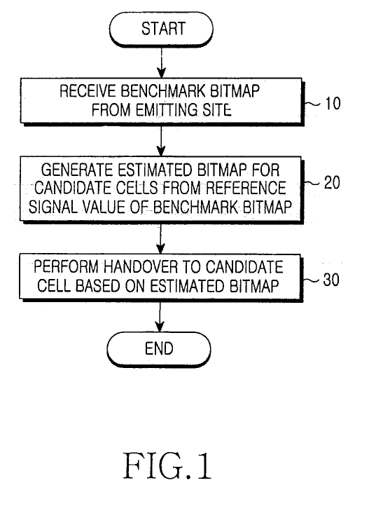

FIG. 1 is a flowchart illustrating a process of bitmap estimation and handover according to an exemplary embodiment of the present invention.

Referring to FIG. 1, a receiver at a boundary between two cells receives benchmark bitmaps from emitting sites of the cells where the receiver is currently located in step 10. The receiver then estimates signal values for the candidate cells using the benchmark bitmaps in order to construct estimated bitmaps in step 20. In step 30, the receiver performs handover to one of the candidate cells, which has the best signal value, according to the estimated bitmaps.

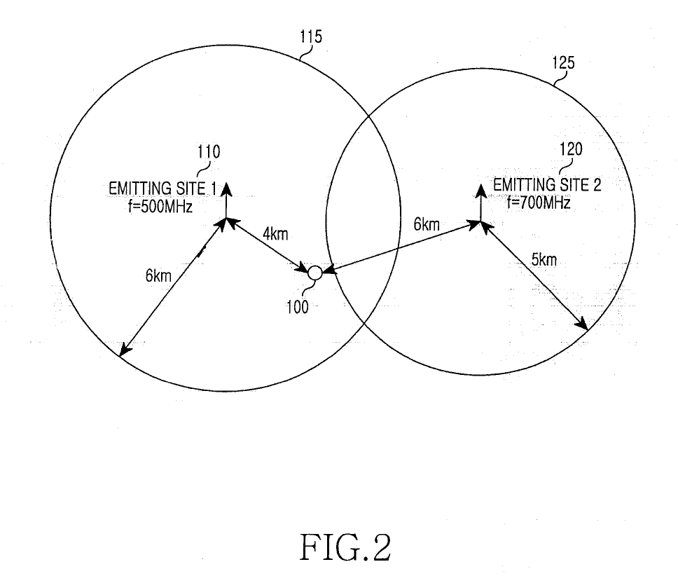

FIG. 2 illustrates a benchmark bitmap according to an exemplary embodiment of the present invention.

As illustrated in FIG. 2, a receiver 100 is located such that a T-R distance from an emitting site 1 (110) is 4 km and a T-R distance from an emitting site 2 (120) is 6 km. A transmitted signal from the emitting site 1 is carried on 800 MHz and a transmitted signal from the emitting site 2 is carried on 500 MHz. Thus, a benchmark bitmap for the emitting site 1 is based on the frequency of 500 MHz, and the boundary of a signal that is good enough to receive is a 6 km radius from the emitting site 1 (which will hereinafter be referred to as a candidate cell 1(115)). A benchmark bitmap for the emitting site 2 is based on the frequency of 700 MHz, and the boundary of a signal that is good enough to receive is a 5 km radius from the emitting site 2 (which will hereinafter be referred to as a candidate cell 2(125)).

To make it simple, it is assumed that the transmitted powers and the antenna gains of the transmitters 110 and 120 and the antenna gain of the receiver 100 are the same in the exemplary embodiment of the present invention.

When signal strength is reduced due to movement of the receiver 100 or the original signal receiving quality is not good, handover is required. In order to decide to which one of candidate cells the receiver 100 can perform handover, the real coverage scope of the candidate cells should be estimated.

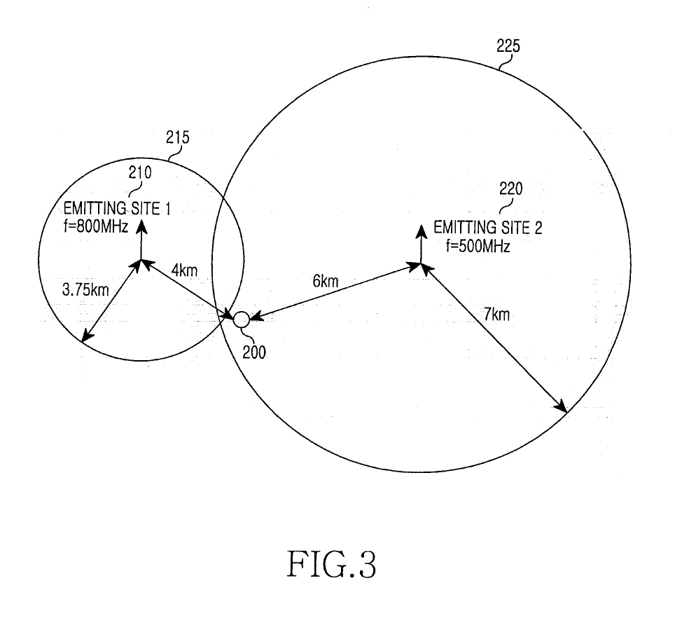

FIG. 3 illustrates an estimated bitmap obtained using Equations 11 and 12 according to an exemplary embodiment of the present invention.

Referring to FIG. 3, for an emitting site 1 (210), the boundary of an 800 MHz signal that is good enough to receive by a receiver 200 can be estimated based on Equation (10) as follows:

$${d}_{candidate 1} = \frac{500}{800} * 6 = 3.75 km \qquad ( 11 )$$

Similarly, for an emitting site 2 (220), the boundary of a 500 MHz signal that is good enough to receive by the receiver 200 can be estimated based on Equation (10) as follows:

$${d}_{candidate 2} = \frac{700}{500} * 5 = 7 km \qquad ( 12 )$$

In other words, although the receiver 200 is physically close to the emitting site 1, it has to perform handover to the candidate cell 2 because it is within the coverage scope, i.e., the candidate cell 2, where the signal sent from the emitting site 2 is good enough to receive by the receiver 200 instead of the coverage scope. i.e., the candidate cell 1, where the signal sent from the emitting site 1 is good enough to receive the receiver 200.

Although the estimated bitmap is used for handover in the present invention, the present invention can also be applied to bitmap generation for Quality of Service (QoS), locations, and the like.

Next, a description will be made regarding a case where an estimated bitmap according to the present invention is applied to handover in a Digital Video Broadcasting (DVB) system to which the present invention is applied. While a Digital Video Broadcasting-Handheld (DVB-H) Convergence of Broadcasting and Mobile Service (CBMS) system is taken as an example of the DVB system herein, the present invention is not limited thereto and can also be applied to other types of DVB system.

The DVB-H CBMS provides more convenient functions by means of the convergence of a digital TV broadcast service having superior mobile reception performance and a mobile communication service. Recently, as analog TVs evolves into digital TVs, users can enjoy a TV service with high video quality of a High Definition (RD) TV level and high audio quality of a Compact Disc (CD) level. However, with diversification tendency of our time, viewers' activities and life patterns much differ from those of the past. Moreover, as portable devices such as cellular phones, Personal Digital Assistants (PDAs), notebook computers, and the like have become common in use, the demand for enjoying a TV service of HD quality while on the move is ever-increasing. Additionally, there has been made much effort to overcome the limitation of a broadcast network having no reverse channel by means of combination with mobile communication, resulting in the DVB-H CBMS.

The DVB-H CBMS is a system configured for a reception terminal capable of using a mobile communication channel and includes the concept of handover supported in a cell-based radio communication system like a conventional mobile communication system. However, handover in a broadcast network is different from that in a mobile communication network that always manages subscribers. For handover in a mobile communication system, a network receives a measurement report from a terminal to manage an individual user and a network including handover. However, for handover in a general broadcast system, a broadcast operator provides a service and contents without managing every user. In other words, the broadcast operator sends information for broadcast reception to all users over a broadcast network and has no user management function. Thus, handover in the broadcast network has unique technical requirements that are distinguished from handover in the mobile communication system.

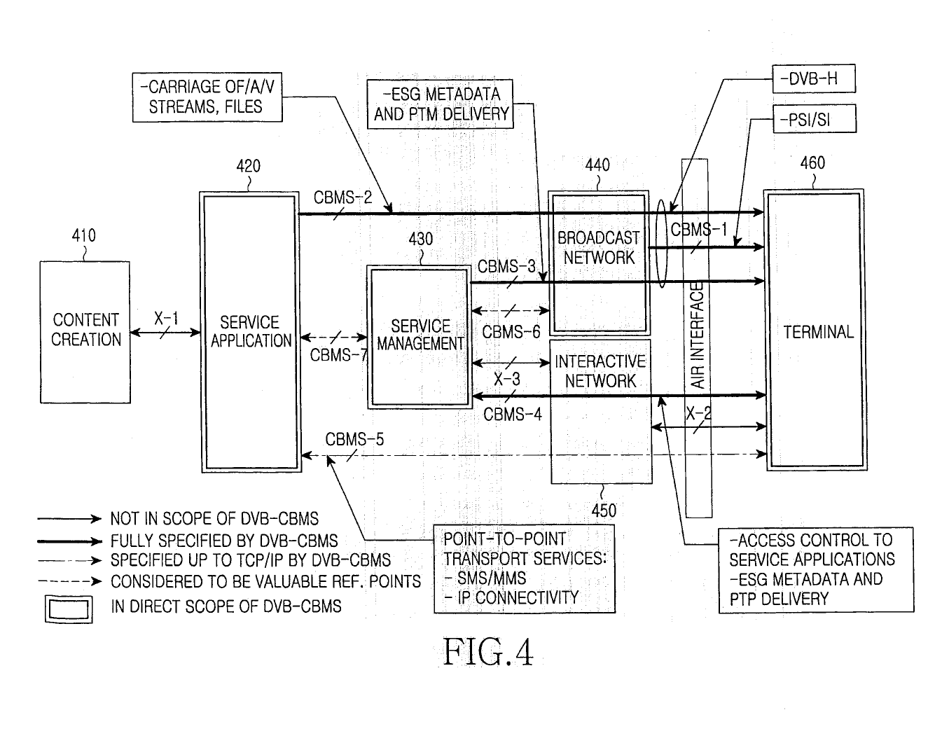

FIG. 4 is a block diagram of a general DVB-H system to which the present invention is applied. Entities illustrated in FIG. 4 are logical entities that can be physically distinguished or cannot be distinguished and can be combined into one or more physical entities. In FIG. 4, only interfaces related to the subject matter of the present invention are shown. The DVB-H system shown in FIG. 4 is intended for the DVB-CBMS, one of handheld broadcasting terminal standard organizations. Although a notification broadcast structure of the DVB-CBMS is taken as an example for convenience of explanation herein, the present invention can also be implemented in other types of handheld broadcasting systems having a notification messaging function in the similar manner.

Referring to FIG. 4, a Content Creation (CC) 410 is a provider of a broadcast service and the broadcast service may include conventional audio/video broadcast services, a file (music file or data file) download service, and the like. If there is any problem in providing the broadcast service or any change in the broadcast service, the CC 410 notifies the problem or change to a notification event generation function in a Service Application (SA) 420.

The SA 420 is provided with content data for the broadcast service from the CC 410 and processes the content data into a form (e.g., audio/video streaming or movie downloading) suitable for a broadcast network in order to generate broadcast service data, generates standardized metadata necessary for an Electronic Service Guide (ESG), and generates billing information according to a user. The SA 420 is also notified of the change in the broadcast service from the CC 410 to deliver a notification event to a notification message generation function in a Service Management (SM) 430 and provides service guide attribute information used for the generation of a notification message to the notification message generation function.

The SM 430 determines a transmission schedule for the broadcast service provided from the SA 420 and generates a service guide. The SA 430 is connected to a broadcast network 440 capable of the broadcast service and an interactive network 450 supporting interactive communication.

In addition, the SM 430 also manages subscriber information for reception of the broadcast service, service provisioning information such as information indicating whether the subscriber has purchased related content, and device information for terminals receiving the broadcast service, transmits user billing information to the SA 420, and provides the subscription information, the service provisioning information and the device information to the broadcast network 440 and the interactive network 450.

The broadcast network 440 is a network for transmitting the broadcast service and DVB-H is taken as an example of the broadcast network 440 herein.

The interactive network 450 transmits the broadcast service on a point-to-point basis or interactively exchanges control information and additional information associated with the reception of the broadcast service, and may be an existing cellular network such as 3GPP Wideband Code Division Multiple Access (WCDMA) network.

A terminal 460 is capable of receiving the broadcast service and has a function of accessing the cellular network according to its capabilities. It is assumed herein that the terminal 460 can access the cellular network.

Next, a description will be made of interfaces between block elements of the DVB-H system.

CBMS-x is an interface within the scope of the IP Datacast over DVB-H specification, and X-x is an interface out of the scope of the IP Datacast over DVB-H specification. More specifically, a CBMS-7 interface is an interface from the SA 420 to the SM 430, and a CBMS-3 interface is an interface used to directly transmit a message from the SM 430 to the terminal 460 on a broadcast channel via the broadcast network 440. A CBMS-4 interface is an interface used to directly transmit the message transmitted from the SA 430 to the terminal 460 via the interactive network 450 on a dedicated channel with the terminal 460 or a broadcast channel provided by the interactive network 450. A CBMS-6 interface is an interface between the SM 430 and the broadcast network 440, which is used to set up a transmission path to be used by the SA 430 in the broadcast network 440 or used as a reception path of event information generated in the broadcast network 440. A CBMS-1 interface is an interface used to deliver a control signal of the broadcast network to the terminal 460. For example, in DVB-H, a control signal channel called Program Specific Information/Service Information (PSI/SI) corresponds to the control signal. An X-3 interface is an interface used to set up a transmission path to be used between the SAM 430 and the interactive network 450. An X-2 interface is an interface used to set up a transmission path to be used between the terminal 460 and the interactive network 450. An X-1 interface is an interface used to set up a transmission path to be used between the CC 110 and the SA 420.

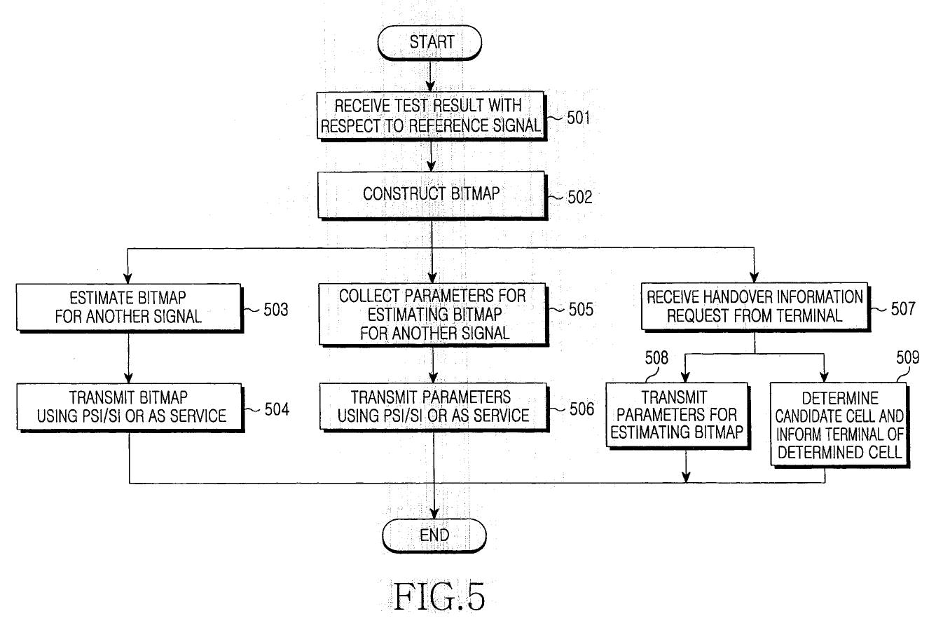

FIG. 5 is a flowchart illustrating the operation of a network according to an exemplary embodiment of the present invention.

Referring to FIG. 5, the network collects test results for a single reference signal received from a receiver in step 501. After selecting a test result, the network constructs a bitmap for a single signal in step 502. The network estimates a bitmap for another signal of another transmitted in the same emitting site based on the constructed bitmap in step 503 and transmits the estimation result using PSI/SI or transmits the estimation result as a single service to a terminal in step 504. The network does not have to test each signal. The network can immediately apply all the tests and the estimation result to the terminal.

The network collects parameters necessary for estimating a bitmap for another signal such as a benchmark bitmap, transmitted power, transmitter antenna gains for a test signal and another signal, and a receiver antenna gain for the test terminal in step 505. The network transmits the collected parameters to the terminal using the PSI/SI or transmits the collected parameters as a service in step 506. The terminal then can estimate a bitmap for a candidate signal based on the information.

Table 1 shows information transmitted to the terminal.

TABLE 1

| Name | | Description |
|---|---|---|
| Bitmap ID | | Identifier for bitmap message |
| Network id | | Identifier for one network |
| Cell id | | Identifier for one cell |
| Latitude | | The value of the latitude for one position |
| longitude | | The value of the longitude for one position |
| altitude | | The value of the altitude for one position |
| Benchmark value | | Value of signal as benchmark |
| | Frequency | Frequency of one signal |
| | Signal quality | Value of the signal quality |
| | transmitted power | Value of transmitted power |
| | transmitter antenna gain | Value of transmitter antenna gain |
| | receiver antenna gain | Value of receiver antenna gain |
| Parameter of other signal | | Some parameters of other signal, used for |
| | | estimation |
| | Frequency | Frequency of one signal |
| | transmitted power | Value of transmitted power |
| | transmitter antenna gain | Value of transmitter antenna gain |

The network can also provide handover information to the terminal at the request of the terminal. In other words, upon reception of information necessary for handover from the terminal in step 507, the network can provide information as shown in Table 1 to the terminal in step 508. In this case, a cell to which handover is to be made is determined by the terminal. The network estimates a candidate cell to which the terminal is to perform handover based on the test result, determines the candidate cell, and informs the terminal of the determined cell in step 509.

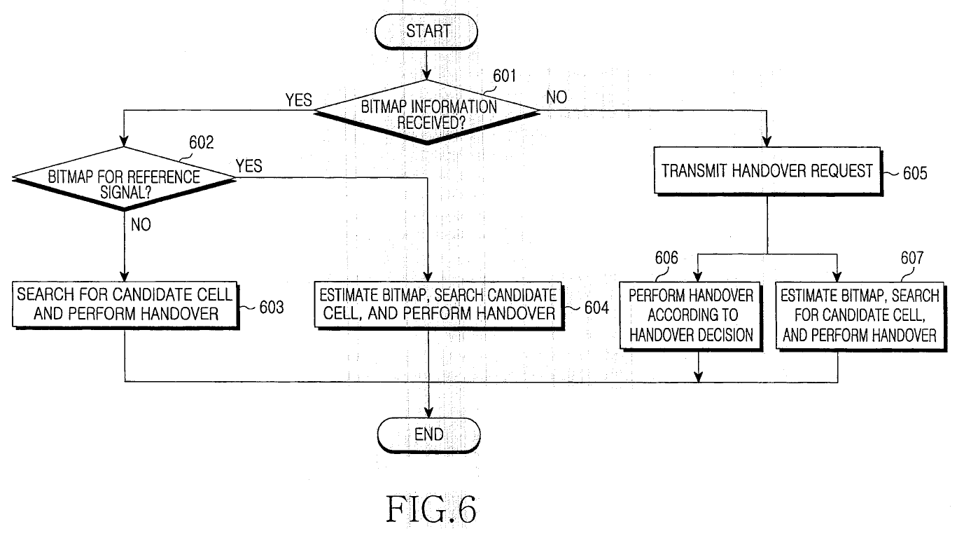

FIG. 6 is a flowchart illustrating the operation of a terminal according to an exemplary embodiment of the present invention.

Referring to FIG. 6, the terminal checks if it receives bitmap information in step 601. If the terminal receives the bitmap information through PSI/SI or a service, it checks if the received bitmap information is bitmap information for all signals or for a reference signal including several parameters. In step 602. If the terminal receives the bitmap information for all signals, it searches for a candidate cell to which handover is to be made and then performs handover to the cell in step 603. If the terminal receives the bitmap information for the reference signal it estimates a bitmap based on the received bitmap information, searches for a candidate cell, and performs handover to the cell in step 604.

In case of a failure to receive the bitmap information from the network, the terminal transmits a handover request message to the network over an interactive channel in step 605. In step 606, the terminal receives a handover decision message from the network and performs handover according to the decision of the network. Alternatively, the terminal receives parameters for bitmap estimation like in Table 1, estimates a bitmap using the received parameters, searches for a candidate cell, and performs handover to the cell in step 607.

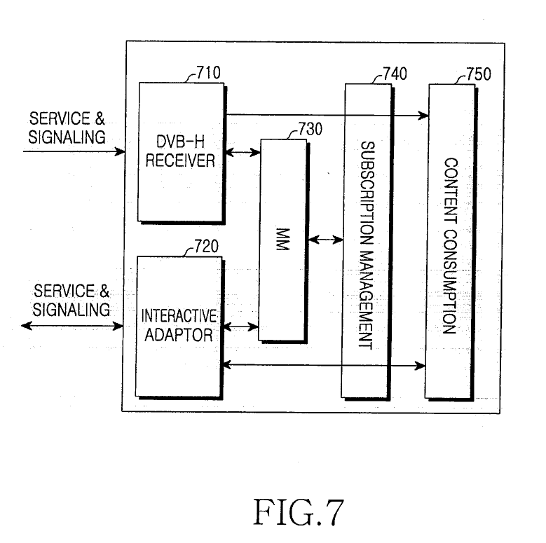

FIG. 7 schematically illustrates the structure of a terminal according to an exemplary embodiment of the present invention.

Referring to FIG. 7, a DVB-H receiver 710 is in charge of reception and reconstruction of a DVB-H broadcast signal. An interactive adaptor 720 provides a service using a mobile communication network. A Mobility Management (MM) 730 manages a reception environment change caused by movement of the terminal. A subscription management 740 manages right acquisition, keeps track of rights acquired for the terminal and controls the decryption process of service contents. A content consumption 750 sends a received broadcast service to a user.

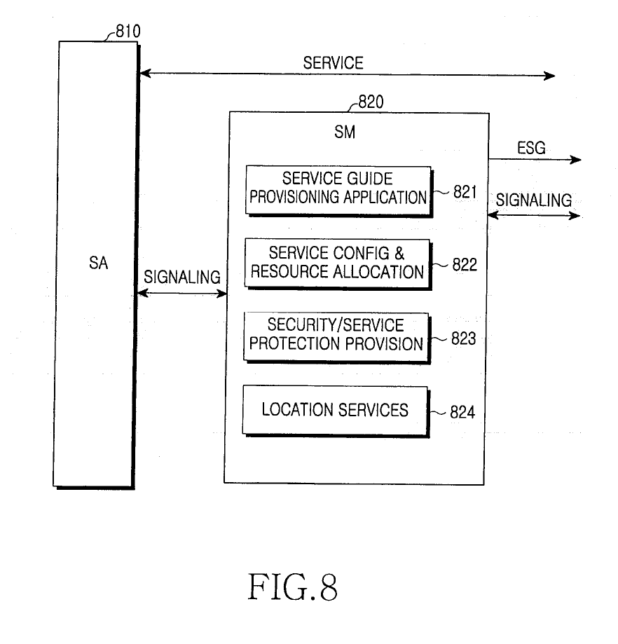

FIG. 8 schematically illustrates the structure of a network according to an exemplary embodiment of the present invention.

Referring to FIG. 8, an SA 810 aggregates contents from multiple sources and their related metadata in order to provide a particular service application, provides head-end application logic, provides contents encoded in the format understood by the terminal either via streaming or file carousel delivery, and generate metadata to be used for an ESG The SA 810 may exist for each application provided in IP Datacast.

A service guide provisioning application 821 aggregates ESG (metadata information) pieces from the SA 810. A Service Management (SM) 820 includes the service guide provisioning application 821, a service configuration/resource allocation 822, a security/service protection provision 823, and a Location Services 824 as its sub-entities. The security/service protection provision 823 manages user access to the SA 810. The service configuration/resource allocation 822 registers service applications that contend for the bandwidth of a broadcast bearer, assigns services to location related to broadcast network topology and bandwidth, and schedules services over time. The Location Services 824 can support a mobile service and communicate with an MM of another network for information exchange.

As is apparent from the foregoing description, maps for a popular frequency are assumed as a benchmark bitmap and maps for other frequencies are constructed based on the benchmark bitmap, thereby remarkably reducing cost imposed by map generation and broadcasting. Moreover, requirements for reliable transmission of multiple maps can be alleviated and the quality of different-frequency maps can be maintained in a fairly reliable fashion, while the total overload of map sharing can be reduced.

While the invention has been shown and described with reference to an exemplary embodiment thereof, it will be understood by those skilled in the art that various changes in form and details may be made therein without departing from the spirit and scope of the invention.

What is claimed is:

1. A method for estimating a signal quality bitmap for cells, the method comprising:
receiving a first benchmark bitmap including a signal quality value for every position within a cell where a receiver is currently located according to a first frequency from an emitting site of the cell;
estimating a first signal quality value for every position within the cell according to a second frequency using the signal quality value for every position in the first benchmark bitmap; and
constructing an estimated bitmap using the estimated first signal quality value.

2. The method of claim 1, further comprising:
when the receiver moves to a boundary between the cell and another cell, receiving a second benchmark bitmap including a signal quality value for every position within the cell according to a third frequency from an emitting site of the another cell;
estimating a second signal quality value for every position within the cell according to a fourth frequency using the signal quality value for every position in the second benchmark bitmap;
constructing an estimated bitmap using the estimated second signal quality value; and
performing handover to one of cells, which has the best signal quality value among the signal quality values of the second estimated bitmaps.

3. The method of claim 1, wherein the estimation of the first signal quality value is performed using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency, Gₜ₂ is a transmitter antenna gain for the second frequency, Gᵣ₁ is a receiver antenna gain for the first frequency. Gᵣ₂ is a receiver antenna gain for the second frequency, and d is a distance from the emitting site to the receiver.

4. The method of claim 2, wherein the estimation of the second signal quality value is performed using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency. Gₜ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.

5. A method for estimating a signal quality bitmap for cells by a network in a digital broadcasting system, the method comprising:
receiving a test result with respect to a reference signal having a first frequency from a test terminal to construct a first benchmark bitmap;
estimating a bitmap for another signal having a second frequency based on the first benchmark bitmap to transmit the estimation result to the terminal using Program Specific Information/Service Information (PSI/SI) or transmit the estimation result as a service to the terminal; and
collecting parameters for estimating a bitmap for the another signal to transmit the collected parameters to the terminal using PSI/SI or transmit the collected parameters as a service to the terminal.

6. The method of claim 5, wherein the parameters include the test result, the benchmark bitmap, transmitted power, a transmitter antenna gain, and a receiver antenna gain.

7. The method of claim 5, further comprising:
receiving a test result having a third frequency transmitted from another cell to construct a second benchmark bitmap;
estimating a signal quality value for every position within a cell according to a fourth frequency using a signal quality value for every position in the second benchmark bitmap and constructing a first estimated bitmap; and
transmitting the estimated bitmap to the terminal.

8. The method of claim 5, wherein the estimation of the bitmap comprises estimating a signal quality value using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency Pₜ₂ is transmitted power for the second frequency, Gₜ₁ is a transmitter antenna gain for the first frequency, Gₜ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.

9. The method of claim 7, wherein the estimation of the signal quality value is performed using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency, Gₜ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.

10. A method for estimating a signal quality bitmap for cells by a terminal in a digital broadcasting system, the method comprising:
checking if a bitmap is received from a network;
checking if the received bitmap is a first benchmark bitmap for a reference signal having a first frequency when the bitmap is received;
estimating a bitmap for another signal having a second frequency based on the benchmark bitmap when the first benchmark bitmap for the reference signal is received, and searching for a candidate cell using the estimation result; and
performing handover according to the search result.

11. The method of claim 10, further comprising:
receiving a second benchmark bitmap including a signal quality value for every position within a cell where a signal having a third frequency is transmitted when the terminal moves to a boundary between two cells;
estimating a signal quality value for every position within the cell according to a fourth frequency using the signal quality value for every position in the second benchmark bitmap;
constructing a second estimated bitmap using the estimated signal quality value; and
performing handover to one of the cells, which has the best signal quality value among signal quality values of the estimated bitmaps.

12. The method of claim 10, wherein the estimation of the bitmap for another signal is performed using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency, Gₜ₂ is a transmitter antenna gain for the second frequency Gᵣ₁ is a receiver antenna gain for the first frequency, Gᵣ₂ is a receiver antenna gain for the second frequency, and d is a distance from the emitting site to the receiver.

13. The method of claim 11, wherein the estimation of the signal quality value is performed using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency Pᵣ(d) is received power for the second frequency, Pₜ₁ is transmitted power for the first frequency, Pₜ₂ is transmitted power for the second frequency, Gₜ₁ is a transmitter antenna gain for the first frequency, Gₜ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.

14. A network device which provides a broadcast service to a terminal and estimates a signal quality bitmap for cells in a digital broadcasting system, the network device comprising:
a Service Application (SA) for aggregating contents from sources and their related metadata in order to provide an application for a particular service; and
a Service Management (SM) for generating an Electronic Service Guide (ESG) for the broadcast service from the metadata collected by the SA and managing roaming of the terminal to a neighboring network,
wherein the SM receives a first test result with respect to a reference signal having a first frequency from a test terminal, constructs a first benchmark bitmap using the received first test result, estimates a bitmap for another signal having a second frequency based on the benchmark bitmap to transmit the estimation result to the terminal using Program Specific Information/Service Information (PSI/SI) or transmit the estimation result as a service to the terminal, and collects parameters for estimating a bitmap for the another signal to transmit the collected parameters to the terminal using PSI/SI or transmit the collected parameters as a service to the terminal.

15. The network device of claim 14, wherein the parameters include the test result, the benchmark bitmap, transmitted power, a transmitter antenna gain, and a receiver antenna gain.

16. The network device of claim 14, wherein the SM receives a second test result having a third frequency transmitted from another cell, constructs a second benchmark bitmap using the received first test result, estimates a signal quality value for every position within a cell according to a fourth frequency using a signal quality value for every position in the benchmark bitmap to construct an estimated bitmap, and transmits the estimated bitmap to the terminal.

17. The network device of claim 14, wherein the SM estimates the bitmap for another signal using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency. Pₜ₂ is transmitted power for the second frequency, Gₜ₁ is a transmitter antenna gain for the first frequency, Gₜ₂ is a transmitter antenna gain for the second frequency. Gᵣ₁ is a receiver antenna gain for the first frequency, Gᵣ₂ is a receiver antenna gain for the second frequency, and d is a distance from the emitting site to the receiver.

18. The network device of claim 16, wherein the SM estimates the signal quality value using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency, Gₜ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.

19. A terminal device which receives a broadcast service from a network and estimates a signal quality bitmap for cells in a digital broadcasting system, the terminal device comprising:
a broadcasting receiver for receiving a broadcast service or signal from a broadcast network;
an interactive adaptor for receiving an interactive service or signal from an interactive network; and
a mobility management and control for managing roaming to a neighboring network,
wherein the broadcasting receiver receives mapping information for services provided from different IP platforms or different providers from a network, and the mobility management and control checks if a received bitmap is a first benchmark bitmap for a reference signal having a first frequency if the bitmap is received from a network, estimates a bitmap for another signal having a second frequency based on the first benchmark bitmap if the first benchmark bitmap for the reference signal is received and searches for a candidate cell using the estimation result, and performs handover according to the search result.

20. The terminal device of claim 21, wherein the mobility management and control, when the terminal moves to a boundary between two cells, receives a second benchmark bitmap including a signal quality value for every position within a cell where a signal having a third frequency is transmitted, estimates a signal quality value for every position within the cell according to a fourth frequency using the signal quality value for every position in the second benchmark bitmap, constructs an estimated bitmap using the estimated signal quality value, and performs handover to one of the cells, which has the best signal quality value among signal quality values of the estimated bitmaps.

21. The terminal device of claim 19, wherein the mobility management and control estimates the bitmap using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency, Gᵣ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.

22. The terminal device of claim 20, wherein the mobility management and control estimates the signal quality value using
$${P}_{r 2} ( d ) = {P}_{r 1} ( d ) * \frac{{P}_{t 2} {G}_{t 2} {G}_{r 2} {d}_{1}^{2} {f}_{1}^{2}}{{P}_{t 1} {G}_{t 1} {G}_{r 1} {d}_{2}^{2} {f}_{2}^{2}}$$
wherein Pᵣ₁(d) is received power for the first frequency, Pᵣ₂(d) is received power for the second frequency, Pₜ₁ is transmitted power for the first frequency, Pₜ₂ is transmitted power for the second frequency, Gₜ₁ is a transmitter antenna gain for the first frequency, Gₜ₂ is a transmitter antenna gain for the second frequency, Gᵣ₁ is a receiver antenna gain for the first frequency, Gᵣ₂ is a receiver antenna gain for the second frequency, and d is a distance from the emitting site to the receiver.
